(19) United States
(12) Patent Application Publication
(10) Pub. No.: US 2012/0018384 A1
(43) Pub. Date: Jan. 26, 2012

(54) MERCURY REMOVAL FROM WATER

(76) Inventor: John Sawyer, Charlestown, WV (US)

(21) Appl. No.: 13/018,390

(22) Filed: Jan. 31, 2011

Related U.S. Application Data
(60) Provisional application No. 61/337,145, filed on Feb. 1, 2010.

(51) Int. Cl. C02F 1/62; C02F 1/68; C02F 1/28; C02F 1/70

(52) U.S. Cl. 210/688; 210/716

(57) ABSTRACT

The present invention provides a method of removing mercury from water. The method includes depositing selenium or a reactive selenium compound on a support structure, such as reticulated foam. The support structure is then placed in contact with mercury laden water whereby allowing the selenium and the mercury in the water to react. The selenium deposited support structure retains the mercury thereby removing the mercury from the mercury laden water.

### REFERENCE TO PENDING APPLICATIONS

This application claims the benefit of U.S. Provisional Patent Application Ser. No. 61/337,145 filed on Feb. 1, 2010 and entitled Mercury Removal From Water.

### REFERENCE TO MICROFICHE APPENDIX

This application is not referenced in any microfiche appendix.

### BACKGROUND OF THE INVENTION

There are several contaminants in surface waters that are of considerable concern due to their effects on wildlife as well as humans. One of the most pervasive is Mercury.

Mercury has been removed to relatively low levels with sulfur and selenium compounds, as well as with other methods. U.S. Pat. No. 4,780,214 discloses a method for treating lakes by slow release of a selenium salt, with sodium selenite being used in the example. While the method worked, the amount of selenium released is above the current EPA guideline of 5 μg/L. U.S. Pat. No. 5,567,223 teaches a method to remove mercury from a gas stream using selenium vapor in a reduced oxygen atmosphere.

Mercury has also been used to remove selenium from mixtures. U.S. Pat. No. 4,038,375 teaches a method to remove selenium from a urethane solution using soluble mercury compounds.

The previous work has demonstrated selenium may be used with increased efficiency over sulfur, but the toxic effects of residual excess selenium have not been addressed. In fact, the selenium level in surface waters is regulated to less than 5 μg/liter to avoid damage to aquatic organisms.

Thus, there is a need for an effective method of contacting the water-borne mercury with selenium in such a manner as to remove the mercury from the water to extremely low levels, while not introducing selenium into the water, and capturing the immobilized mercury and selenium.

### BRIEF SUMMARY OF THE INVENTION

The present invention satisfies the needs discussed above. The present invention is generally directed toward an apparatus and method for the refinement of waste materials into biological based fuels.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

The present invention is directed toward a method of removing mercury from water. One aspect of the present invention includes the steps of depositing selenium on a support structure. The support structure is then placed in contact with a mercury laden water. The selenium and the mercury in the water react allowing support structure to retain the mercury and removing it from the water.

Another aspect of the present invention includes using a reactive selenium compound in place of selenium. Further, the support structure can be defined as a monolithic structure and can be made from reticulated foam with or without a coating of zero valent iron (ZVI) particles or zinc rich particles.

Another aspect of the present invention includes depositing the selenium onto the surface of a high surface area support, such as high surface area silica, alumina, zeolite, and other metal oxides. The selenium can be impregnated on the surface of the high surface area support with an additional reductant.

The said high surface area support being attached to a substrate, such as reticulated foam, honeycomb structure with a multiplicity of longitudinal channels, or some other suitable high surface area substrate.

Upon reading the above description, various alternative embodiments will become obvious to those skilled in the art. These embodiments are to be considered within the scope and spirit of the subject invention, which is only to be limited by the claims which follow and their equivalents.

### DESCRIPTION OF THE INVENTION

The present invention is generally directed toward a method of removing mercury from surface waters using selenium that is immobilized in a reticulated foam structure, thereby incorporating the mercury into the foam structure.

It is understood that there are several ways of carrying out the invention, and the description is intended to be illustrative, and not restrictive.

One method of providing selenium that is reactive with mercury, but nonetheless completely insoluble, is to deposit the selenium on the surface of zero valent iron (ZVI) particles. These particles may be formed into a reticulated foam structure to enhance mass transfer and contact with the water. In this embodiment, the ZVI serves to prevent solubilization of the selenium, while supporting the selenium and allowing reaction with the mercury in the water stream. The ZVI is also available to reduce the mercury ions to the elemental zero-valent state, enhancing the reaction with the selenium.

The reticulated foam structure is most conveniently a urethane foam. Another suitable support structure is a honeycomb structure, with a plurality of open channels through a solid one piece, monolithic structure. Other suitable support structures are the structured or unstructured materials used for enhanced mass transfer in areas such as distillation.

Another method is to deposit selenium particles on the support structure along with the ZVI particles, adhering both to the foam. The intent is to have the particles in as close proximity with each other to the extent possible. The ZVI is present to reduce the mercury to the elemental state, and to ensure no release of the selenium. Other reductants may be substituted for the ZVI such as zinc powder, or a copper/zinc powder. A preferred copper/zinc powder has a relatively high surface area, in concert with excess zinc above the amount which will dissolve in copper, yielding a separate zinc phase in the metal particles.

Another method is to adhere the selenium particles directly to the substrate without the benefit of a reductant. This embodiment is suitable and preferred when the water chemistry is such that the mercury may be readily absorbed by the selenium, but the selenium is not subject to oxidation and solubilization. The reductant may also be placed downstream of the selenium bearing substrate to scavenge any selenium released during operation.

An additional method of achieving the removal of mercury by selenium is to deposit selenium onto the surface of a high surface area support, such as high surface area silica, alumina, zeolite, of another metal oxide, the support being attached to a substrate such as a reticulated foam, or a honeycomb structure with a multiplicity of longitudinal channels, or some other suitable high surface area substrate. The selenium may be impregnated on the surface of the support with or without an additional reductant.

An additional method of depositing the selenium on the support is to react a soluble selenide such as potassium selenide with a metal salt that precipitates a metal selenide on the surface of the support. Additional reductant may also be co-precipitated or deposited separately on the support to prevent oxidation and solubilization of the selenium.

The foam support for each of these methods is a reticulated foam structure made from any suitable material, but preferably polyether or polyurethane, as disclosed previously. The adherant may be as disclosed previously, any suitably tacky material possessing the desired resistance to continuous water contact. The material of the substrate may itself be made tacky, and used directly without the need for a further adherent.

These methods all provide a reticulated foam with an open structure which provides a low pressure drop, and sufficient selenium contact area to remove mercury from the water as the contaminated water flows through the foam structure.

### EXAMPLE I

A reticulated foam substrate was coated with a siliconized acrylic adherent, and contacted with particles of ZVI such that the entire surface was covered with ZVI. The excess ZVI particles were removed. The foam was in four individual disks 25.4 mm thick and 67 mm in diameter. A dilute solution of selenate ions at about neutral pH was passed over the ZVI coated structure to load the surface of the ZVI with selenium until the selenium removal efficiency dropped to below 50%. The resulting selenium coated ZVI reticulated foam was contacted with a solution of mercury ions in water. The mercury inlet concentration was measured at 7.71 ppb Hg. A total of about 82% of the Hg was removed from the water with a superficial contact time of 18 minutes. With a contact time of 62 minutes, the removal was about 93%.

### EXAMPLE II

A reticulated foam substrate was coated with a siliconized acrylic adherent, and contacted with particles of selenium such that the entire surface was covered with selenium. The excess selenium particles were removed. The foam was in four individual disks 25.4 mm thick and 67 mm in diameter. The resulting selenium coated reticulated foam was contacted with a solution of mercury ions in water. The mercury inlet concentration was measured at 6.69 ppb Hg. A total of about 69% of the Hg was removed from the water with a superficial contact time of 18 minutes. With a contact time of 62 minutes, the removal was about 80%.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. A method of removing mercury from water comprising the following steps:
depositing selenium on a support structure; and
placing said selenium deposited support structure in contact with a mercury laden water whereby allowing said selenium and the mercury in said mercury laden water to react and thereby allowing said selenium deposited support structure to retain said mercury and thereby removing said mercury from said mercury laden water.

2. The method of removing mercury from water of claim 1 wherein said step of depositing is further defined as depositing a reactive selenium compound on a suitable support structure.

3. The method of removing mercury from water of claim 1 wherein said support structure is defined as being reticulated foam.

4. The method of removing mercury from water of claim 1 wherein said support structure is defined as a reticulated foam coated with zero valent iron (ZVI) particles.

5. The method of removing mercury from water of claim 1 wherein said support structure is defined as a monolithic structure.

6. The method of removing mercury from water of claim 1 wherein said support structure is defined as a reticulated foam coated with zinc rich particles.

7. The method of removing mercury from water of claim 1 wherein said selenium is deposited onto the surface of a high surface area support, said high surface area support being attached to a substrate.

8. The method of removing mercury from water of claim 7 wherein said selenium being impregnated on said surface of said high surface area support with an additional reductant.

9. The method of removing mercury from water of claim 7 wherein said substrate is made from the group consisting of high surface area silica, alumina, zeolite, and another metal oxides.

10. The method of removing mercury from water of claim 7 wherein said substrate is made from the group consisting of reticulated foam, a honeycomb structure with a multiplicity of longitudinal channels, or some other suitable high surface area substrate

11. The method of removing mercury from water of claim 1 comprising the additional step of:
providing a structure downstream of said mercury removal step to remove any selenium solubilized in the mercury removal step.

12. The method of removing mercury from water of claim 11 wherein said substrate is made from the group consisting of reticulated foam, a honeycomb structure with a multiplicity of longitudinal channels, or some other suitable high surface area substrate

13. The method of removing mercury from water of claim 11 wherein said step of depositing is further defined as depositing a reactive selenium compound on a suitable support structure.

14. The method of removing mercury from water of claim 11 wherein said support structure is defined as being reticulated foam.

15. The method of removing mercury from water of claim 11 wherein said support structure is defined as a reticulated foam coated with zero valent iron (ZVI) particles.

16. The method of removing mercury from water of claim 11 wherein said support structure is defined as a monolithic structure.

17. The method of removing mercury from water of claim 11 wherein said support structure is defined as a reticulated foam coated with zinc rich particles.

18. The method of removing mercury from water of claim 11 wherein said substrate is made from the group consisting of high surface area silica, alumina, zeolite, and another metal oxides.

19. The method of removing mercury from water of claim 11 wherein said substrate is made from the group consisting of reticulated foam, a honeycomb structure with a multiplicity of longitudinal channels, or some other suitable high surface area substrate.

20. A process as in claim 11 where said selenium being deposited onto said surface of said high surface area support by reacting a soluble selenide with a metal salt that precipitates a metal selenide on the surface of said support.
